(19) United States
(12) Patent Application Publication
(10) Pub. No.: US 2023/0003103 A1
(43) Pub. Date: Jan. 5, 2023

(54) METHOD AND CONTROL SYSTEM NODE FOR MONITORING OPERATIONS ON DRILL FLOOR

(71) Applicant: MHWIRTH AS, KRISTIANSAND S (NO)

(72) Inventors: PETTER MYDLAND, KRISTIANSAND S (NO); GEIR LIEN, KRISTIANSAND S (NO); NICOLAI NILSEN, KRISTIANSAND (NO); ERLAND NYJORDET, GRIMSTAD (NO)

(73) Assignee: MHWIRTH AS, KRISTIANSAND S (NO)

(21) Appl. No.: 17/801,523

(22) PCT Filed: Mar. 12, 2021
(86) PCT No.: PCT/NO2021/050063

§ 371 Date: Aug. 23, 2022

(30) Foreign Application Priority Data
Mar. 12, 2020 (GB) 2003572.1

(51) Int. Cl. E21B 41/00; E21B 44/10

(52) U.S. Cl. CPC E21B 41/0021; E21B 44/10

(57) ABSTRACT

A method for controlling drilling operations includes defining operation zones in a drilling operation area, each operation zone having equipment operating therein, and repeatedly performing the steps of: determining a position of at least one person in the drilling operation area, determining whether the respective determined position is within any of the operation zones and associating each person to the operation zone in which the person is located, determining whether the respective determined position is within a safety zone in proximity to the equipment, determining at least one action to be performed with regard to each operation zone in which the person has been determined to be present, and transmitting at least one control signal for controlling the drilling operations based on the at least one action determined. The at least one action is determined dependent on whether or not the position of the person is in the safety zone.

### CROSS REFERENCE TO PRIOR APPLICATIONS

This application is a U.S. National Phase application under 35 U.S.C. § 371 of International Application No. PCT/NO2021/050063, filed on Mar. 12, 2021 and which claims benefit to Great British Patent Application No. 2003572.1, filed on Mar. 12, 2020. The International Application was published in English on Sep. 16, 2021 as WO 2021/182972 A1 under PCT Article 21(2).

### TECHNICAL FIELD

The invention relates to a method and a control system node for monitoring operations to increase safety on a drill floor or a wellsite.

### BACKGROUND

In general, for modern oil and gas well drilling rigs, numerous automation systems have been developed to enhance safety, for example by removing personnel from high-risk areas (so-called “red zones”) at a drill floor or a wellsite. However, these automation systems may still require people for effective monitoring and controlling of various equipment in these areas in order to achieve desired operations. The risk of injury to the people or personnel increases when the people are in the proximity to the equipments which are moving and/or rotating continuously on the drill floor.

### SUMMARY

There exists a need for an improved drill floor and/or wellsite safety methods and apparatus.

It is an objective of the present invention to provide improvements over the state of the art in at least one of the abovementioned areas, or at least to provide alternatives to known technology.

The present disclosure relates to a method for controlling drilling operations. The method comprises a step of defining a plurality of operation zones in a drilling operation area, each operation zone comprising at least one equipment arranged to operate in the operation zone.

The method may comprise repeatedly performing the steps of: determining the position of at least one person in the drilling operation area; determining whether the respective determined position is within any of the defined operation zones and associating each person to the operation zone in which the person is located; determining whether the respective determined position is within a safety zone in proximity to the one or more equipments; determining one or more actions to be performed with regard to each operation zone in which a person has been determined to be present, wherein the at least one action is determined dependent on whether the position of the person is in the safety zone or not; and transmitting one or more control signals for controlling the drilling operations in accordance with the determined one or more actions.

Thereby, intelligent management of operation zones in a drilling operation area can be achieved. The operation zones can be defined based on type of equipment operating in the respective zone and which types of operations are presently carried out by the equipment in the respective zone. If for example operation of an equipment has been temporarily stopped, there is no need to define an operation zone corresponding to this equipment during the stop. When operation of the equipment is resumed, an operation zone associated to that equipment can then be formed.

The positions of persons moving in the drilling operation area can then be assessed in relation to updated and relevant operation zones. Further, as actions are determined in relation to whether the persons determined to be present in the operation zones are in a safety zone in proximity to the equipment, or outside the safety zone, the actions taken are adequate for the situation.

This solution is especially useful in situations, where it is not possible to avoid that people are present while equipments are operating. For example offshore drilling rigs are crowded and it is not always possible to avoid presence of people where equipment is operating.

This solution allows for eliminating unnecessary people in the safe zone(s) while managing “must have” personnel.

Drilling operations may be optimized while safety in the safety zone(s) can be maximized.

In some embodiments, the step of determining one or more actions comprises determining a first type action when a person has been determined to be in the safety zone and determining a second type action when no person has been determined to be in the safety zone. For example, the first type action may comprise stopping operation of the equipment. The second type action may comprise reducing the speed of the equipment. For example, the speed of the equipment may be reduced to 50%.

In some embodiments, the second type action is determined based on the number or persons which has been determined to be present within the operation zone. For example, when the second type action comprises reducing the speed of the equipment, the speed reduction may be dependent on the number of persons present in the operation zone. The second type action may also or instead be dependent on where in the operation zone person(s), who are not in the safety zone, are present.

In some embodiments, at least one of the operation zones comprises multiple sub-zones, wherein one of the multiple sub-zones is the safety zone.

In some embodiments, the extension of the plurality of operation zones, and/or the extension of the sub-zones, are defined in accordance with a type of operations carried out by equipment in the respective operation zone. The operation type may for example be selected from at least comprising at least one of the following operation types.
picking up tubular
laying down tubular
tripping in hole
tripping out of hole
wet trip
drilling connection
back reamer
running riser
stand building
casing building
laying down tubulars via stand building system

The extension of the plurality of operation zones may be adaptively redefined in accordance with the type of operations presently carried out by the equipment in the respective operation zone.

A size and/or a shape of each operation zone may be configurable. For example, the size and/or shape of each operation zone may be manually configurable, for example via a user interface. For example, the size and/or shape of the respective operation zone may be pre-configurable in accordance with the type of operation carried out in that operation zone and the size and/or shape may then be manually refined using the user interface.

The step of determining the position of the person in the drilling operation area may comprise extracting data related to the position of the person through one or more sensors installed in the plurality of operation zones; and calculating a location of the person based on the extracted data.

The step of determining whether the position of a person is in a safety zone may comprise:
obtaining a bounding box enclosing the person;
obtaining one or more bounding boxes enclosing one or more equipments in each operation zone; and
determining whether the person is proximate the equipment based on a relative position between the bounding box of the person and the bounding boxes of the one or more equipments.

The method comprises in different embodiments further a step of determining for each equipment said safety zone using equipment sensors; wherein said determined safety zone is used in determining whether the respective determined position is within the safety zone.

In some embodiments, the at least one action comprises at least one of the following precautions:
activating at least one of an alarm, a buzzer, a safety barrier and a light indicator,
stopping operation of the equipment,
reducing speed of the equipment,
altering path of the equipment,
altering movement of the equipment,
notifying an operator of the equipment
identifying a person leaving the safety zone or operation zone, or
automatically adapting control in accordance therewith.

Some of the actions exemplified above may be used as first type actions. Some of the actions exemplified above may be used as second type actions. Some of the actions exemplified above may be used both as first type actions and second type actions.

For example, the alarm, buzzer, safety barrier and/or light indicator may be activated when a person enters the safety zone. The alarm, buzzer, safety barrier and/or light indicator may be kept activated as long as the person is within the safety zone.

Operation of the equipment may be stopped when a person enters the safety zone. The operation of the equipment may be stopped at least as long as the person is within the safety zone. Operation may be resumed when the person exits the safety zone.

An operator of the one or more equipments may be notified when the person is within the safety zone.

An indication may be provided to a person within the safety zone to move away from the safety zone.

In some embodiments, the method further comprises a step of determining an operational status of the one or more equipments, wherein the at least one action is determined based on the operational status.

In some embodiments, the method comprises obtaining a sequence of instructions for execution of one or more operations of the one or more equipments of at least one of the operation zones, and controlling said one or more equipment in accordance with said obtained sequence of instructions.

In practice, when a new type of operation is to be performed, an operation zone may be defined corresponding to that operation type, as discussed above, and a sequence of instructions for execution of this new type operation is obtained. Then, the equipment is controlled in accordance with the obtained sequence of instructions.

The step of determining one or more actions to be performed may then comprise, instead of or in addition to the actions discussed above, at least one of: altering one or more planned operations of the one or more equipments; and delaying one or more planned operations of the one or more equipments.

In some embodiments, automatically controlling the operations of the one or more equipments may comprise: executing a first instruction in the sequence of instructions; redefining the plurality of operation zones upon executing the first instruction; and executing a second instruction in the sequence of instructions.

The operation zones may be updated for each new instruction carried out by the respective equipment.

In some embodiments, the method further comprises a step of identifying whether a person in the operation zone is an authorized person. The one or more actions to be performed is then determined based on the identification of whether the person in the operation zone is authorized. For example, a safety indication may be provided to the person if the identified person is not an authorized person.

The present disclosure also relates to a control system node for controlling operations in a drilling operation area. The control system node comprises a storage and a processor coupled to the storage. The control system node is configured to perform the method as defined above.

The present disclosure further relates to a method for monitoring operations in a drilling operation area. The method comprises
providing one or more bounding boxes enclosing one or more equipments in each operation zone among a plurality of operation zones of the drilling operation area;
identifying the movement of the one or more bounding boxes;
evaluating whether the movement of the one or more bounding boxes is in accordance with a predetermined sequence of operations for the equipment enclosed by the bounding box; and
performing one or more actions in response to the evaluation.

A size and a shape of each bounding box may be configurable.

The size and the shape of each bounding box may be configurable based on a state of the one or more equipments.

The size and the shape of each bounding box may be automatically varied in accordance with planned sequence of operation of the one or more equipments.

The movement of the one or more bounding boxes may be continuously monitored and the performing of one or more actions in response to the evaluation comprises automatically controlling the operations of one or more equipments.

In some embodiments, automatically controlling the operations of one or more equipments comprises: identifying whether the bounding box enclosing one equipment overlaps the bounding box of another equipment when moving according to the predetermined sequence of operations; and allowing the overlap of the bounding boxes in response to identifying that the movement of the bounding boxes is executed in accordance with a planned operation.

In some embodiments, automatically controlling the operations of one or more equipments comprises: identifying whether the movement of the one or more bounding boxes enclosing the one or more equipments is not in accordance with a planned operation; and controlling the one or more equipments to avoid the one or more equipments being in contact, in response to identifying that the movement of the one or more bounding boxes is not in accordance with a planned operation.

The present disclosure also relates to a control system node for monitoring operations in a drilling operation area. The control system node comprises: a storage and a processor coupled to the storage. The control system node may be configured to perform the methods as discussed above.

The present disclosure further relates to a method for monitoring tools in a drilling operation area. The method comprises: registering available tools in a drilling operation area; monitoring one or more tools of the registered available tools, said monitored one or more tools being carried for performing various operations on the equipments; detecting presence of the one or more tools on the equipments upon completion of the various operations on the equipments; and performing one or more actions in response to detecting the presence of the one or more tools on the equipments.

Performing one or more actions may comprise activating at least one of an alarm, a buzzer, a safety barrier and a light indicator to indicate safety about impending risk to one or more persons in the drilling operation area.

The present disclosure further relates to a control system node for monitoring operations in a drilling operation area. The control system node comprises a storage and a processor coupled to the storage. The control system node is configured to: register available tools in the drilling operation area; monitor one or more tools of the registered available tools, said one or more tools being carried for performing various operations on the equipments; detect presence of the one or more tools on the equipments upon completion of the various operations on the equipments and perform one or more actions in response to detecting the presence of the one or more tools on the equipments.

The control system node may be configured to perform one or more actions comprising activating at least one of an alarm, a buzzer, a safety barrier and a light indicator to indicate safety about impending risk to one or more persons in the drilling operation area.

### BRIEF DESCRIPTION OF THE DRAWINGS

The above and other characteristics will become clear from the following description of embodiments, given as non-restrictive examples, with reference to the attached schematic figures.

FIG. 1 illustrates a drilling operation area comprising various operational equipments in a plurality of operation zones.

FIG. 2 illustrates a plurality of operation zones of an equipment operating on a drill floor.

FIG. 3 is an example illustration of a position of a person relative to an equipment in a drilling operation area.

FIG. 4 is an example illustration of bounding boxes enclosing equipments in a drilling operation area.

FIGS. 4a and 4b illustrate example safety indications provided to the person based on a position of a person relative to an equipment in a drilling operation area.

FIG. 5 illustrates a control system node comprising various modules for monitoring operations in a drilling operation area.

FIG. 6a is a flow chart illustrating an example of a method for controlling drilling operations in a drilling operation area.

FIG. 6b is a flow chart illustrating an example of a step for determining action(s) to be performed in the method of FIG. 6a.

FIG. 7 is an example illustration of providing a safety indication to a person in a drilling operation area.

FIG. 8 illustrates various steps for performing sequence of instruction in a drilling operation area while redefining the operation zones.

FIG. 9 is a flow chart illustrating an example of a step for determining whether a position is within a safety zone, which step may part of the method of FIG. 6a.

FIG. 10 is a flow chart illustrating an example of a method for monitoring operations in a drilling operation area.

FIGS. 11a and 11b illustrate an example of movement of equipments in a drilling operation area by enclosing the equipments in bounding boxes.

FIGS. 11c and 11d illustrate an example of a variation in shape of the bounding boxes in accordance with a type of operations of the equipments.

FIG. 12 is a flow chart illustrating an example of a method for monitoring tools in a drilling operation area.

FIG. 13 is an example illustration for providing safety indication to the person about presence of various tools on equipments.

FIGS. 14a-c are example illustrations of the position of a person relative to an equipment in a drilling operation area.

### DETAILED DESCRIPTION

Various examples of the present disclosure will now be described in detail with reference to the accompanying drawings. In the following description, specific details such as detailed configuration and components are merely provided to assist the overall understanding of these examples. Therefore, it should be apparent to those skilled in the art that various changes and modifications of the examples described herein can be made without departing from the scope of the present disclosure. In addition, descriptions of well-known functions and constructions are omitted for clarity and conciseness.

Also, the various examples described herein are not necessarily mutually exclusive, as some examples can be combined with one or more other examples to form new examples.

The following description may use terms such as “horizontal”, “vertical”, “lateral”, “back and forth”, “up and down”, “upper”, “lower”, “inner”, “outer”, “forward”, “rear”, etc. These terms generally refer to the views and orientations as shown in the figures and that are associated with a normal use of the invention. The terms are used for the reader's convenience only and shall not be limiting.

Throughout the description, the terms a control system node and a control node are used interchangeably.

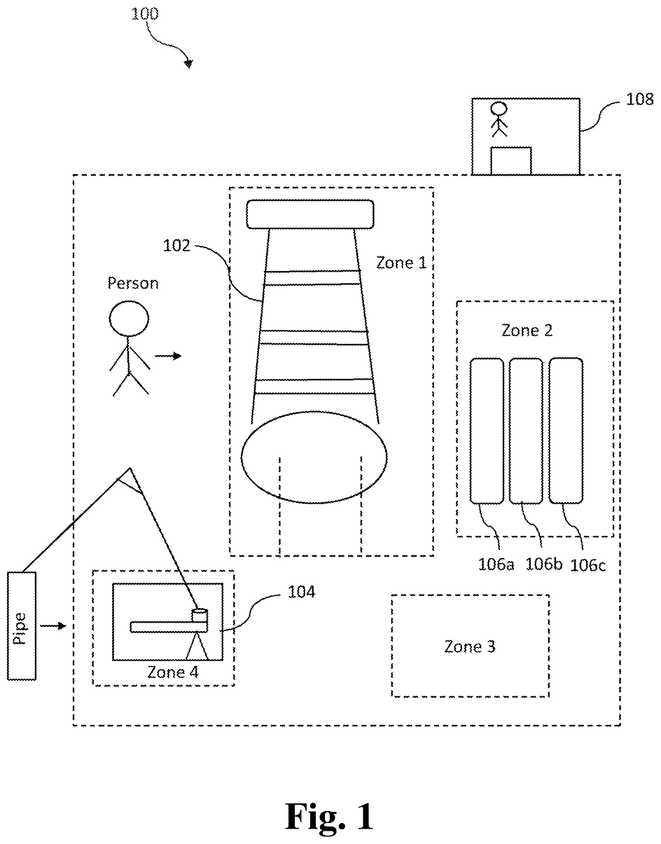

Referring now to the drawings, and more particularly to FIGS. 1 through 14, where similar reference characters denote corresponding features consistently throughout the figures.

FIG. 1 illustrates a drilling operation area for example comprising a drill floor 100 comprising various operational equipments. As depicted in FIG. 1, the drill floor 100 comprises various drilling components such as a derrick 102, a pipe handling machine 104, and a plurality of hoisting cylinders 106a, 106b and 106c. The drilling operation area comprises further in the illustrated example a driller's cabin 108 situated external to the drill floor 100. The drill floor 100 may include many other drilling components other than the components shown in FIG. 1 for performing various drilling operations on the drill floor 100 with various equipments.

The driller's cabin 108 may include various control equipments, control system nodes, required control circuitry and other monitoring systems. The various control equipments in the driller's cabin 108 may have communication with the equipments on the drill floor 100 or wellsite via equipment sensors coupled to each equipment or one or more rig sensors located on the drill floor 100 for monitoring various operations of the equipments 102, 104 and 106a-106c on the drill floor 100.

Although many of the equipments on the drill floor 100 are automated and/or operated remotely (e.g., such as from the driller's cabin 108 or from a control room located away from the equipments), there are still numerous personnel often working on, or adjacent to the drill floor 100 during an oil and gas operation. The personnel are required to be involved for monitoring and controlling various equipments and operations of those equipments on the drill floor 100. However, the risk of injury to the personnel increases when the personnel are in the proximity of equipments rotating and/or moving on the drill floor 100. Therefore, it is the objective of the present disclosure to provide an improved drill floor 100 that provides some safety indications to the personnel who are in the proximity of the equipments and to automatically control the equipments when the personnel are in proximity.

In an embodiment, a plurality of operation zones namely operation zone 1, operation zone 2, operation zone 3 and operation zone 4 are defined on the drill floor 100 as illustrated in FIG. l. The plurality of operation zones defined on the drill floor 100 may be higher depending on the number of equipments and types of operations being performed on the drill floor 100. Alternatively, the plurality of operation zones defined on the drill floor 100 may be less depending on the number of equipments and, types of operations being performed on the drill floor 100.

Each operation zone covers a part of the drill floor 100 as illustrated in FIG. 1. In an example, the size and shape of each operation zone can be configurable such that each operation zone covers the equipments present in that operation zone. Therefore, the size and shape of the respective operation zone may be configurable based on the type of equipment 102, 104 and 106a-106c and the type of operations performed on the drill floor 100. At least some of the operation zones comprises a safety zone (not illustrated) in proximity to the equipment.

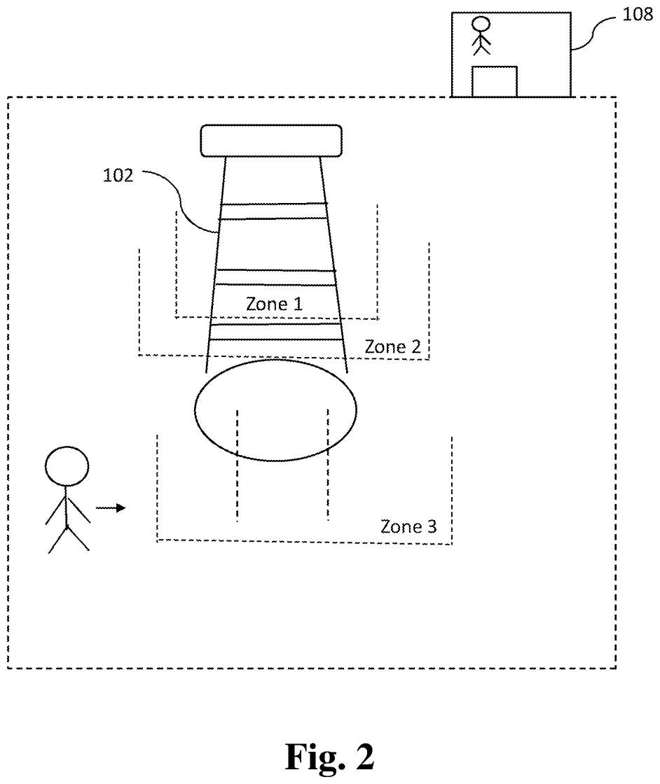

FIG. 2 illustrates an example, wherein at least one of the operation zones comprises multiple sub-zones, wherein one of the multiple sub-zones is the safety zone. For example, the operation zone associated to the derrick 102 on the drill floor 100 comprises three sub-zones namely sub-zone 1, sub-zone 2 and sub-zone 3. One of the sub-zones i.e., either sub-zone 1 or sub-zone 2 or sub-zone 3 may be defined as a safety zone for the derrick 102. For example, sub-zone 1 which is closer to the derrick 102 can be defined as a safety zone.

Therefore, it should be noted that the drill floor 100 may include plurality of operation zones, where each operation zone covers a part of drill floor 100 as illustrated in FIG. 1. Further, the operation zone may be divided into a plurality of sub-zones, as illustrated in FIG. 2.

The operation zones may be equipped with sensors for monitoring the operations of various equipments 102, 104 and 106a-106c. In some examples, each equipment 102, 104, 106a-106c,108 on the drill floor 100 can have equipment sensor(s) which may have wired and/or wireless communication with one or more control nodes or control system nodes in the driller's cabin 108. The equipment sensors may be attached to the equipments 102, 104, 106a-106c and can be configured to transmit one or more signals corresponding to the location of the specific equipment. The signals received from the equipment sensors may be used to monitor and/or control the operation of the equipments 102, 104, 106a-106c.

In some examples, the personnel may be wearing one or more sensors. These sensors may be used to track the location of the personnel wearing the sensor by transmitting the signals corresponding to the location of the sensors to the control nodes possibly located in the driller's cabin 108. The sensors can include, a global positioning system (GPS), radio frequency identification (RFID), a video camera or a motion sensor capable of monitoring the position of the personnel. The sensors may be embedded in clothing of the personnel or coupled to the pair of gloves worn by the personnel.

A control node possibly located the driller's cabin 108 may be adapted to receive and process signals from the sensors to determine positions of personnel and/or equipments. For example, a GPS enabled transmitting sensor may provide geographical location and time information to the control node to determine position or location of the personnel.

The control node determines the position of at least one person in the drilling operation area and determines whether the respective determined position is within any of the defined operation zones. Each person is the associated to the operation zone in which the person is located.

Further, the control node identifies a position of a person in the drilling operation area relative to each equipment 102, 104,106a-106c in the operation zones using the equipment sensors and/or the sensors worn by the personnel. Further, the control node may be configured to evaluate whether the person is in proximity to the one or more equipments based on the identified position. For example, the control node obtains the position information of the equipment from the equipment sensors and the position information of the person using the sensors worn by the personnel. The control node then evaluates whether the person is within a safety zone in proximity to the one or more equipments based on the position information of the equipment and/or the position information of the person.

If the control node determines that the person is in within the operation zone, then the control node may perform one or more actions for automatically or manually controlling the operations of equipments in the drilling operation area and/or for notifying person(s) present in the operation area and/or for notifying an operator of the equipment. The actions may include, for example, stopping operation of the equipment(s) when the person is within the safety zone, reducing speed of the equipment(s), altering path of the equipment(s), altering movement of the equipment(s) and notifying an operator of the equipment(s).

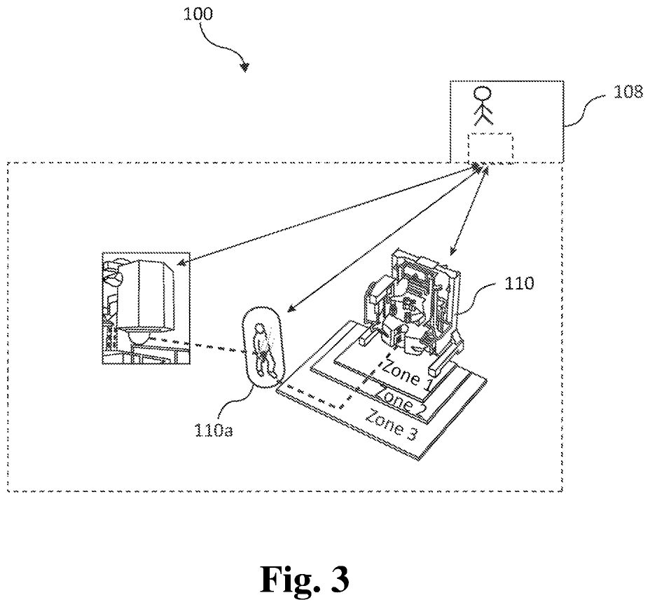

FIG. 3 is an example illustration of a position of a person relative to an equipment 110 on the drill floor 100. As depicted in FIG. 3, the equipment 110 on the drill floor 100 can be defined with zones namely zone 1, zone 2 and zone 3 which can be represented as Red, Yellow and Green respectively. For example, the zone 1 indicated as Red can be considered as a safety zone for the equipment. If the user enters the zone 1, the control node may provide a safety indication to alert the user about an impending risk or danger and may also notify the user to leave from the safety zone, i.e., zone 1.

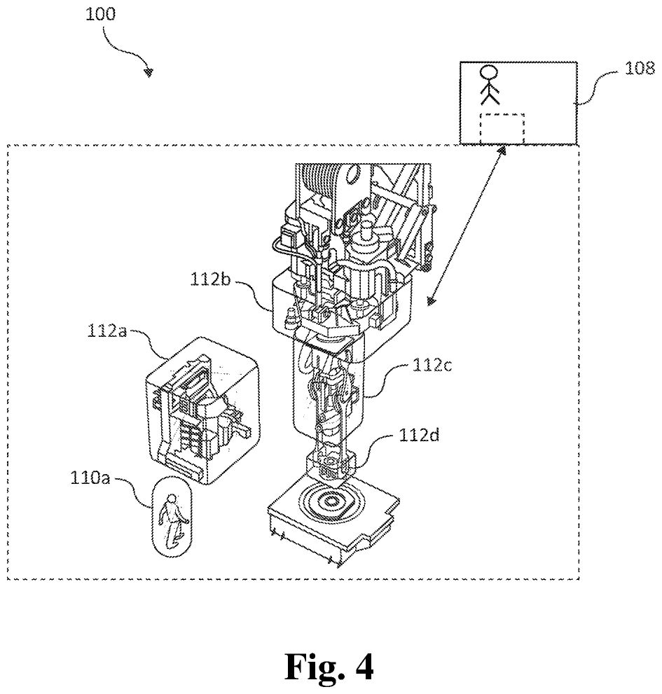

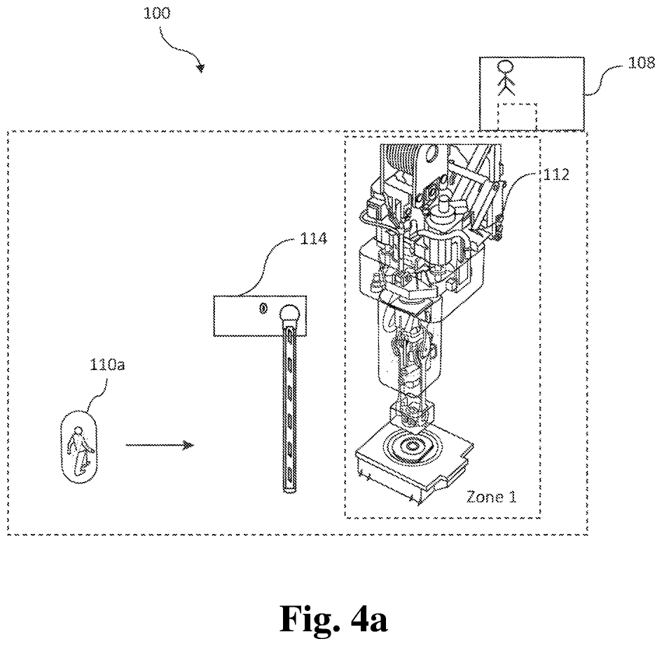

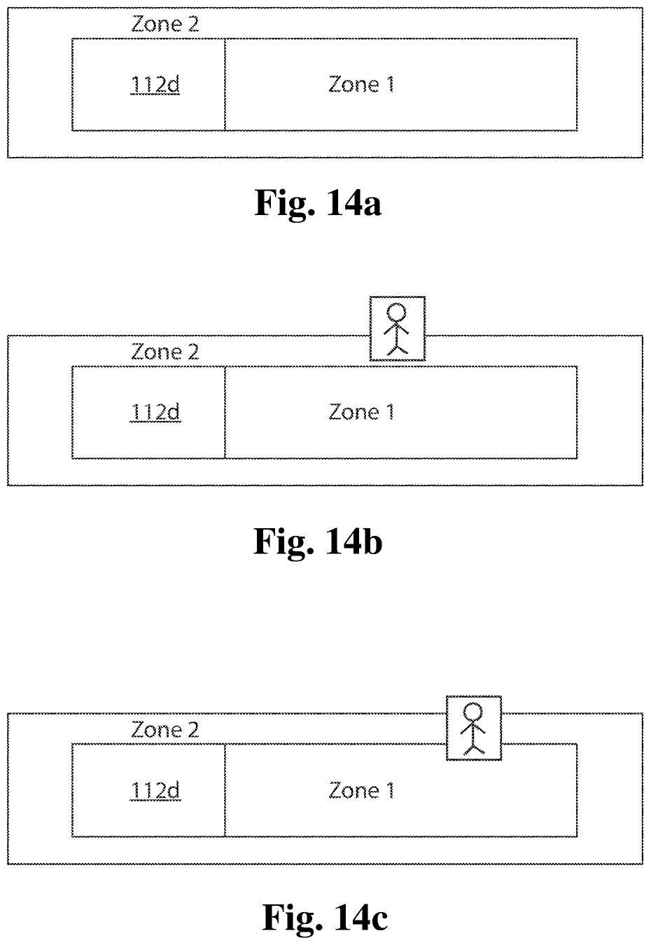

In different examples, a bounding box 110a which encloses the person as illustrated in FIG. 3 is provided for tracking the position of the relative to the equipment 110. The bounding boxes 112a-112d may also be provided for enclosing the equipments on the drill floor 100 as illustrated in FIG. 4. These bounding boxes 110a, 112a-112d are provided such that they enclose the outer perimetry of the person or the equipments. FIG. 14a similarly illustrates a top view of a part of a drill floor, wherein a bounding box 112d is defined around an equipment, and two zones, Zone 1 and Zone 2, are defined in relation to the equipment and its actual or planned operation. In FIG. 14b, a person has moved into Zone 2, which may trigger a first response, as described above and below, and in FIG. 14c, a person has moved into Zone 1, which may trigger a different or additional response, as described above and below.

The determination of whether the position of a person is in a safety zone may as discussed above determined by the position of the person within an operation zone relative to the equipment 102, 104,106a-106c of that operation zone. The determination of whether the position of a person is in a safety zone may be determined based on a relative position between the bounding box 110a of the person and the bounding boxes 112a-112d of the equipments. For example, the control node may determine the position of the person by monitoring the movement of the bounding box 110a enclosing the person. Further, the control node may determine the movement of the equipments by monitoring the movement of the bounding boxes which enclose the equipments. Therefore, the control node may determine whether the person is near or within a safety zone by determining a relative position between the bounding box 110a of the person and the bounding boxes 112a-112d of the equipment(s). Thus, the control node may determine movement of the bounding box 110a of the person and the movement of the bounding boxes 112a-112d of the equipment(s) to determine whether the person is near or within a safety zone of the equipment 112.

FIGS. 4a and 4b illustrate example safety indications provided to the person based on a position of a person relative to an equipment on a drill floor. As depicted in FIG. 4a, the person is moving towards the equipment 112 operating in safety zone 1 (i.e., a safety zone of the equipment 112). The control node may be configured to determine the movement of the bounding box 110a of the person and the movement of the bounding boxes 112b-112d of the equipment 112 to determine whether the person is near or within a safety zone of the equipment 112. When the person is determined to be nearing the safety zone of the equipment 112, the control node may be configured to provide a safety indication to the person by automatically close the barrier 114 as illustrated in FIG. 4a in order to stop the person from entering the safety zone of the equipment 112. The barrier 114 may be a gate, a barricade, a safety boom, an enclosed structure, or the like which may alert or indicate the person about an impending risk of entering the safety zone of the equipment 112.

In an example, the barrier 114 may be activated automatically upon determining that the person is entering the safety zone of the equipment 112. Alternatively, the barrier 114 may be displayed as graphical element or a graphical object such as a safety icon which indicates the person about an impending risk of entering the safety zone of the equipment 112.

In another example, a safety indication to the person about an impending risk of entering the safety zone of the equipment 112 can be provided with a light indicator 116 as illustrated in FIG. 4b. For example, the person is indicated about not to enter the safety zone of the equipment 112 by activating a red light on the light indicator 116 (the light at the top of the indicator). The yellow light (middle light of the indicator) when activated indicates the person to wait for a time interval for completing an ongoing operation by the equipment 112. The green light indication (the light at the bottom of the indicator) allows the person to enter the safety zone of the equipment.

In some examples, an alarm or a buzzer may be activated automatically upon detecting the user entering the safety zone of the equipment 112.

Thus, the person may be indicated about safety by activating the barrier 114, the light indicator 116, an alarm or a buzzer, or the like, where these safety indications may be activated automatically. Alternatively, these safety indications may be activated with manual control of the barrier 114, the light indicator 116, an alarm or a buzzer, or the like. Therefore, the control node enables one or more safety indications to the person on the drill floor through the one or more indications as described above.

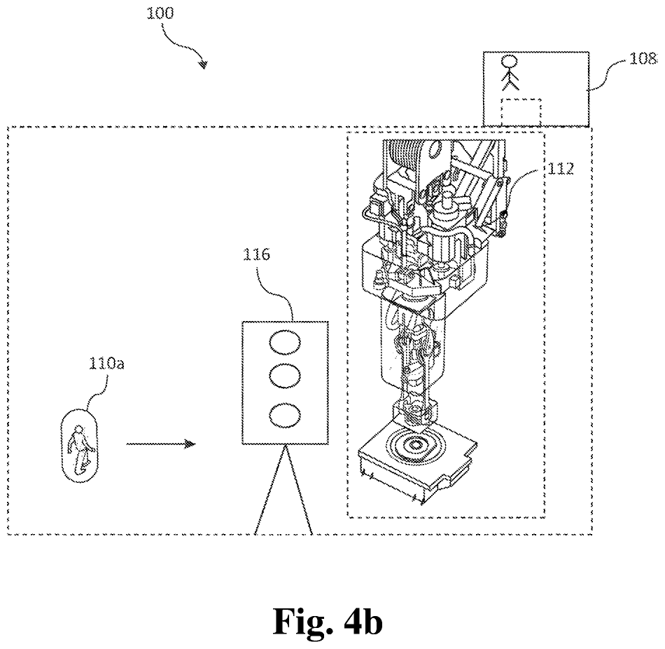

FIG. 5 illustrates a control system node 500 comprising various modules 502-516 for monitoring operations in a drilling operation area such as a drill floor 100, as disclosed in this disclosure. As illustrated in FIG. 5, the control system node 500 includes a communicator 502, a zone classifier 504, a position identifier 506, a position evaluator 508, a storage 510, a drilling controller 512, a processor 514 and a display 516.

The communicator 502 can be configured to receive and process signals from equipment sensors and/or sensors worn by the personnel. The communicator 502 can be adapted to support one or more suitable communication protocols to receive and process signals from the equipment sensors and/or the sensors worn by the personnel.

The zone classifier 504 can be configured to define plurality of operation zones in a drilling operation area, such as operation zone 1, operation zone 2, operation zone 3 and operation zone 4 in the drilling operation area as illustrated in FIG. 1. Further, the zone classifier 504 can be configured to define the plurality of sub-zones for example sub-zone 1, sub-zone 2 and sub-zone 3 for an equipment in a drilling operation area, as illustrated in FIG. 2. Thus, the zone classifier 504 can be configured to define the plurality of operation zones on the drill floor 100 and/or it can be configured to define plurality of sub-zones for each equipment, wherein the sub-zones may include the safety zone. In some examples, the zone classifier 504 can be configured to redefine the plurality of operation zones in accordance with a type of operations carried out by the equipment in said operation zone. For example, after the equipment executes a first action (such as rotation of a pipe) in a sequence of tasks in the drilling operation area, the zone classifier 504 can be configured to redefine the plurality of operation zones in accordance with a second task to be executed by the equipment before starting execution of this second task in the sequence of tasks of the equipment. Thus, the zone classifier 504 may be configured to redefine the plurality of operation zones in accordance with the type of operations performed in the drilling operation area.

The position identifier 506 can be configured to identify the position of a person in a drilling operation area. The position identifier 506 can be configured to extract data or information related to the position of the person through one or more sensors installed in the plurality of zones. Further, the position identifier 506 can be configured to calculate a location of the person based on the extracted data from the sensors. Furthermore, the position identifier 506 can be configured to determine whether the person is near or within an operation zone and/or safety zone among the plurality of operation zones using the location of the person. Thus, the position identifier 506 can be configured to determine positions of the person and/or other equipments 102, 104 and 106a-106c using data extracted from the sensors. For example, a GPS enabled transmitting sensor may provide geographical location and time information to the control system node 500 to determine location and/or positions of the person wearing the sensors. The position identifier 506 can be configured to communicate the determined positions of the person and/or other equipments 102, 104,106a-106c to the position evaluator 508.

The position evaluator 508 can be configured to evaluate whether the person is in the safety zone in proximity to the one or more equipments based on the identified position(s) of the equipment sensors and the positions of the sensors worn by the person (i.e., received from the position identifier 506). The position evaluator 508 can be configured to evaluate whether the person is in the safety zone in proximity to the one or more equipments by comparing the identified position(s) of the equipment sensors and the positions of the sensors worn by the person.

In an example, the position evaluator 508 can be configured to evaluate whether the person is near or within a safety zone among the plurality of zones by determining a relative position between the bounding box 110a provided to the person and the bounding boxes 112a-112d of the one or more equipments.

The storage 510 can be configured to store the position information of the person and the position information of the various equipment sensors. The storage 510 can be configured to store the information related to the sequence of operations of the various equipments on the drill floor 100. Further, the storage 510 can be configured to store various instructions for execution of those instructions by the processor 514.

The drilling controller 512 can be configured to perform one or more actions in response to evaluating that the person in proximity to the one or more equipments 102, 104,106a-106c in the drilling operation area. For example, the drilling controller 512 can be configured to stop the operations of the equipment(s) 102, 104, 106a-106c when the person is within the safety zone of that equipment 102, 104,106a-106c, reduce speed of the equipment 102, 104, 106a-106c, alter path of the equipment 102, 104,106a-106c, alter movement of the equipment 102, 104, 106a-106c and notifies an operator of that equipment 102, 104, 106a-106c or the like.

In some examples, the drilling controller 512 can be configured to receive the position of the user continuously from the position identifier 506. When it is identified that the person has left the safety zone of a particular equipment, based on the information received from the position identifier 506, the drilling controller 512 can be configured to automatically re-start the operation of that equipment.

In some embodiments, the drilling controller 512 can be configured to continuously monitor the operations of the equipments 102, 104 and 106a-106c in the operation zones and can be configured to automatically control the operations of the equipments based on the identified position of the person relative to each equipment 102, 104 and 106a-106c in the safety zones.

The display 516 can be configured to display the various ongoing operations of the equipments 102, 104, 106a-106c in the drilling operation area on a display screen for example provided in the driller's cabin 108 for monitoring purpose. The display 516 can be configured to display the positions of the person(s) in the drilling operation area relative to the operation zone and/or safety zone related to the respective equipment 102, 104, 106a-106c. The person(s) in the driller's cabin 108 may monitor the various operations of the equipments 102, 104,106a-106c in the drilling operation area by continuously monitoring the display screen showing the operation of the equipments 102, 104,106a-106c. The display 516 may be provided in the form of a Graphical User Interface (GUI) through which the person(s) in the driller's cabin 108 may remotely monitor and control the various operations of the equipments 102, 104,106a-106c in the drilling operation area.

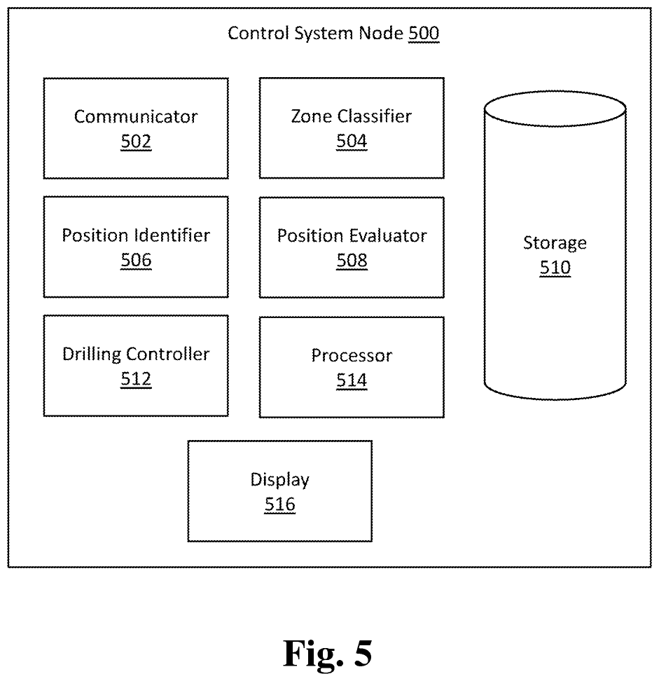

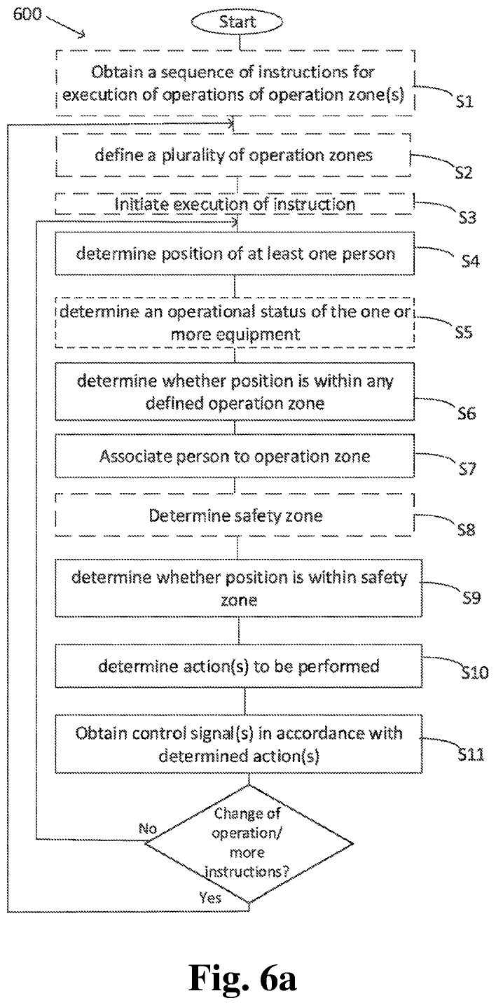

FIG. 6a is a flow chart 600 illustrating a method for controlling drilling operations in a drilling operation are.

The method may comprise a step of obtaining 51 a sequence of instructions for execution of operations of the one or more equipments of at least one of the operation zones.

In this regard, an instruction corresponds to one or more steps carried out by the equipment to perform an operation.

The method comprises a step of defining S2 a plurality of operation zones in a drilling operation area, each operation zone comprising at least one equipment arranged to operate in the operation zone. At least one of the operation zones may comprise multiple sub-zones, wherein one of the multiple sub-zones is a safety zone. The extension of the plurality of operation zones, and possibly the extension of the sub-zones, are defined in accordance with a type of operations carried out by equipment in the respective operation zone. The operation type may for example be selected from a list comprising at least some of the following operation types.
picking up tubular
laying down tubular
tripping in hole
tripping out of hole
wet trip
drilling connection
back reamer
running riser
stand building
casing building
laying down tubulars via stand building system

The extension of the plurality of operation zones may be adaptively redefined in accordance with the type of operation presently carried out by the equipment in the respective operation zone.

A size and/or a shape of each operation zone may be configurable. For example, the size and/or shape of each operation zone may be manually configurable, for example via a user interface. For example, the size and/or shape of the respective operation zone may be pre-configurable in accordance with the type of operation carried out in that operation zone and the size and/or shape may then be manually refined using the user interface.

The method may then comprise a step of initiating execution S3 of an operation of the respective equipment. The execution may when the execution comprises executing a sequence of instructions, comprise initiating execution of the first instruction in the sequence of instructions to perform a first operation.

The method further comprises repeatedly performing the following steps.

It is determined S4 the position of at least one person in the drilling operation area. The step of determining S4 the position of the person in the drilling operation area may comprise extracting data related to the position of the person through one or more sensors installed in the plurality of operation zones; and calculating a location of the person based on the extracted data. The position of the at least one person may be determined S4 in accordance with any of the examples as presented herein.

The method may then comprise a step of determining S5 an operational status of the one or more equipments.

It is then determined S6 whether the respective determined position is within any of the defined operation zones.

Each person is then associated S7 to the operation zone in which the person is located.

The method may then further comprise a step of determining S8 for each equipment said safety zone using sensors for example arranged at the equipment.

It is then determined S9 whether the respective determined position is within a pre-set safety zone in proximity to the one or more equipments or the determined S8 safety zone.

The step of determining S9 whether the position of a person is in a safety zone may comprise
obtaining a bounding box enclosing the person;
obtaining one or more bounding boxes enclosing one or more equipments in each operation zone; and
determining whether the person is proximate the equipment based on a relative position between the bounding box of the person and the bounding boxes of the one or more equipments.

The method further comprises a step of determining S10 one or more actions to be performed with regard to each operation zone in which a person has been determined to be present, wherein the at least one action is determined dependent on whether the position of the person is in the safety zone or not.

The step of determining one or more actions may comprise determining a first type action when a person has been determined to be in the safety zone and determining a second type action when no person has been determined to be in the safety zone. For example, the first type action may comprise stopping operation of the equipment. The second type action may comprise reducing the speed of the equipment. For example, the speed of the equipment may be reduced to 50%.

The second type action may be determined based on the number or persons which has been determined to be present within the operation zone. For example, when the second type action comprises reducing the speed of the equipment, the speed reduction may be dependent on the number of persons present in the operation zone. The second type action may also or instead be dependent on where in the operation zone person(s), who are not in the safety zone, are present.

The at least one action may comprise at least one of the following precautions:
activating at least one of an alarm, a buzzer, a safety barrier and a light indicator,
stopping operation of the equipment (102, 104, 106a-106c),
reducing speed of the equipment (102, 104, 106a-106c),
altering path of the equipment (102, 104, 106a-106c),
altering movement of the equipment (102, 104 and 106a-106c) and
notifying an operator of the equipment (102, 104, 106a-106c).
(i) identifying a person leaving the safety zone or operation zone, and
(ii) automatically adapting control in accordance therewith.

Some of the actions exemplified above may be used as first type actions. Some of the actions exemplified above may be used as second type actions. Some of the actions exemplified above may be used both as first type actions and second type actions.

For example, the alarm, buzzer, safety barrier and/or light indicator may be activated when a person enters the safety zone. The alarm, buzzer, safety barrier and/or light indicator may be kept activated as long as the person is within the safety zone.

Operation of the equipment may be stopped when a person enters the safety zone. The operation of the equipment may be stopped at least as long as the person is within the safety zone. Operation may be resumed when the person exits the safety zone.

An operator of the one or more equipments may be notified when the person is within the safety zone.

An indication may be provided to a person within the safety zone to move away from the safety zone.

When an operational status of the one or more equipments has been determined, the at least one action may be determined based on the operational status.

The method further comprises a step of transmitting S11 one or more control signals for control in accordance with the determined one or more actions.

In different embodiments, the method comprises obtaining a sequence of instructions for execution of one or more operations of the one or more equipments of at least one of the operation zones, and controlling said one or more equipment in accordance with said obtained sequence of instructions.

In practice, when a new type of operation is to be performed, an operation zone may be defined corresponding to that operation type, as discussed above, and a sequence of instructions for execution of this new type operation is obtained. Then, the equipment is controlled in accordance with the obtained sequence of instructions.

The step of determining one or more actions to be performed may then comprise, instead of or in addition to the actions discussed above, at least one of: altering one or more planned operations of the one or more equipments; and delaying one or more planned operations of the one or more equipments.

In different embodiments of the present invention, automatically controlling the operations of the one or more equipments may comprise:
executing a first instruction in the sequence of instructions;
redefining the plurality of operation zones upon executing the first instruction; and
executing a second instruction in the sequence of instructions.

Thus, the operation zones may be updated for each new instruction carried out by the respective equipment.

In different embodiments the method further comprises a step of identifying whether a person in the operation zone is an authorized person. The one or more actions to be performed is then determined based on the identification of whether the person in the operation zone is authorized. For example, a safety indication may be provided to the person if the identified person is not an authorized person.

The present disclosure also relates to a control system node for controlling operations in a drilling operation area. The control system node comprises a storage and a processor coupled to the storage. The control system node is configured to: perform the method as defined above.

The various actions, acts, blocks, steps, or the like in the flow chart 600 may be performed in the order presented, in a different order or simultaneously. Further, in some embodiments, some of the actions, acts, blocks, steps, or the like may be omitted, added, modified, skipped, or the like without departing from the scope of the invention.

FIG. 6b is a flow chart illustrating an example of a step for determining action(s) to be performed in the method of FIG. 6a. In FIG. 6b, the step of determining S10 one or more actions comprises determining S102 a first type action when a person has been determined to be in the safety zone and determining S101 a second type action when no person has been determined to be in the safety zone. In an example, the second type action is determined based on the number or persons which has been determined to be present within the operation zone. Other examples of the one or more actions are described for example in relation to FIG. 6a.

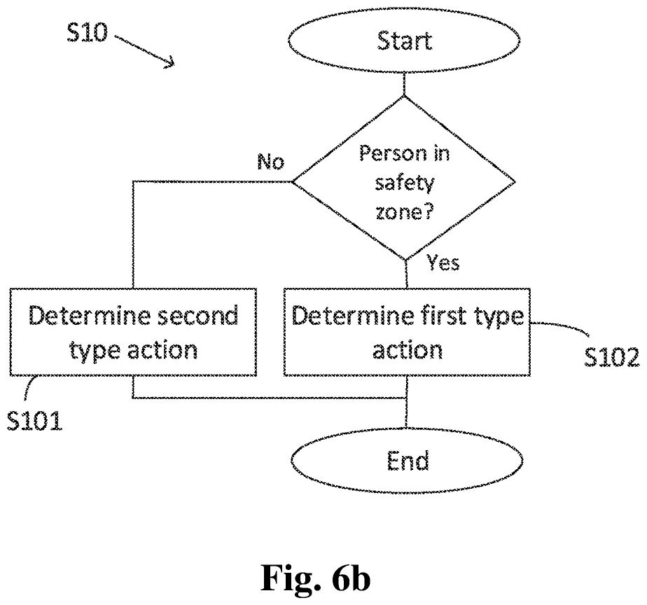

FIG. 7 is an example illustration of providing a safety indication to a person in the drilling operation area. As illustrated in FIG. 7, the person is moving in the drilling operation area. When the person enters a safety zone (for example zone 1 in the illustrated example) of the equipment 110, the control system node 500 provides a safety indication to the person. The safety indication may include activating an alarm indication to indicate the person to leave from the safety zone of the equipment 110.

In an example, the control system node 500 can be configured to identify whether the person in the safety zone to be an authorized person. If the control system node 500 identifies the person to be the authorized person, then the control system node 500 may not activate the alarm to provide the safety indication, as the person is identified as the authorized person who is required to be present at the safety zone to enable the equipment 110 and/or for monitoring and controlling equipment 110 to perform required operations.

In case, the control system node 500 identifies the person not to be the authorized person, then the control system node 500 may activate the alarm to indicate to the person to leave from the safety zone of the equipment 110.

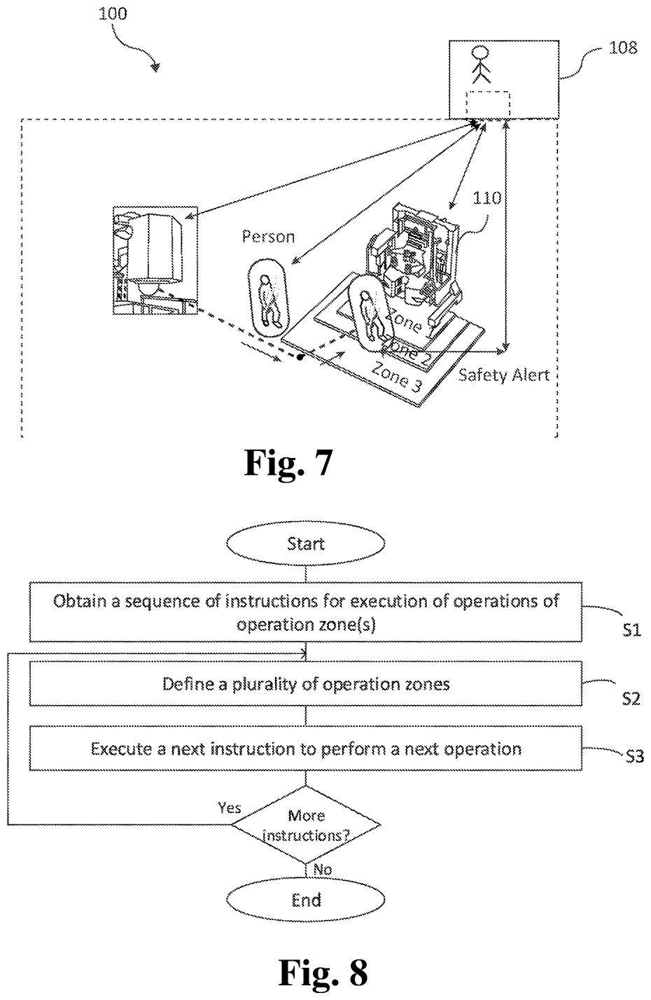

FIG. 8 illustrates an example of various steps in performing sequence of instructions in a drilling operation area by redefining the zones. These steps may for example be carried out in the methods as discussed in relation to FIG. 6a. As depicted in FIG. 8, at step 1, the plurality of operation zones are defined in the drilling operation area such as zone 1, zone 2, zone 3, and zone 4 as illustrated in FIG. 1. When carrying out the methods as disclosed in relation to FIG. 6a., this corresponds to step S2. At step 2, the automated sequence of instructions are extracted. When carrying out the methods as disclosed in relation to FIG. 6a, this corresponds to step 51. At step 3, a first instruction in the sequence of instructions is executed. When carrying out the methods as disclosed in relation to FIG. 6a, this corresponds to step S3. Upon execution of the first instruction, the plurality of operation zones are redefined. When carrying out the methods as disclosed in relation to FIG. 6a, this corresponds to that the process goes back to execution of step S2. Then, a second instruction in the sequence of instructions is executed. When carrying out the methods as disclosed in relation to FIG. 6a, this corresponds to step S3. Further, after execution of the second instruction, the plurality of zones are redefined again. Therefore, in this embodiment, the plurality of zones are continuously redefined upon execution of the instructions among the pre-defined sequence of instructions. In this regard, an instruction corresponds to one or more steps carried out by the equipment to perform an operation.

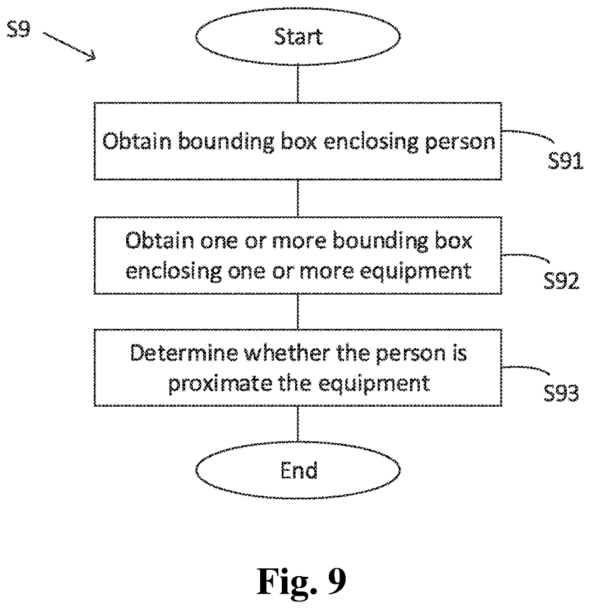

FIG. 9 is a flow chart illustrating various steps in accordance with an example of a step of determining S9 whether the position of a person is in a safety zone. The step S9 of determining whether the position is in a safety zone may be performed in the methods 600 as discussed in relation to FIG. 6a. The step S9 of determining whether the position is in a safety zone comprises in the illustrated example of FIG. 9 obtaining S91 a bounding box 110a enclosing the person; obtaining S92 one or more bounding boxes 112a-112d enclosing one or more equipments 102, 104, 106a-106c in each operation zone; and determining S93 whether the person is proximate the equipment based on a relative position between the bounding box 110a of the person and the bounding boxes 112a-112d of the one or more equipments 102, 104, 106a-106c.

Movement of the one or more bounding boxes 112a-112d enclosing the equipment(s) and/or the bounding box 110a enclosing the person is identified and the determination S93 whether the person is proximate the equipment is updated when a movement has been identified.

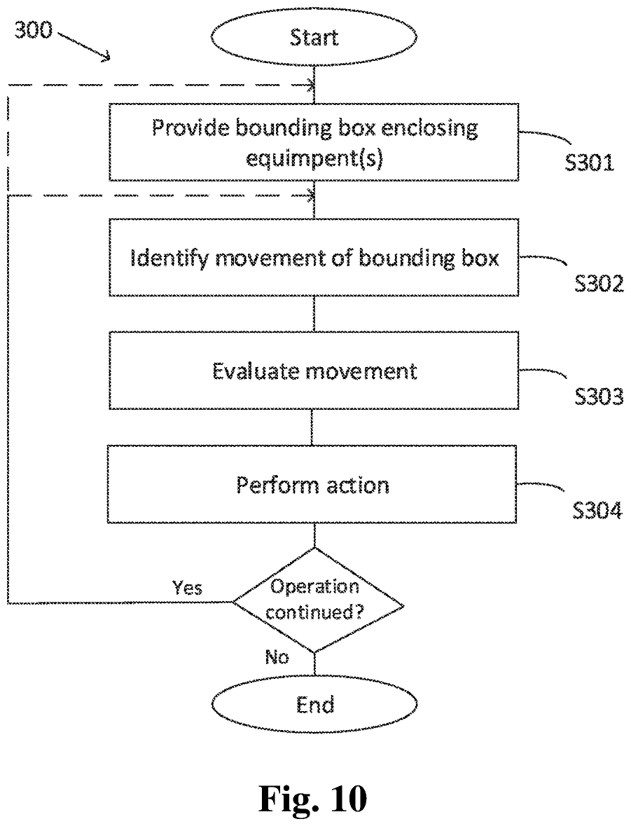

FIG. 10 is a flow chart illustrating a method 300 for monitoring operations in a drilling operation area.

The method comprises a step of providing one or more bounding boxes 112a-112d enclosing one or more equipments 102, 104 and 106a-106c in each operation zone among a plurality of operation zones in the drilling operation area. A size and a shape of each bounding box 112a-112d is configurable. The size and/or the shape of each bounding box 112a-112d may be configurable based on a state of the one or more equipments 102, 104, 106a-106c). The size and/or the shape of each bounding box 112a-112d may be automatically varied in accordance with planned sequence of operation of the one or more equipments 102, 104, 106a-106c.

The method comprises a step of identifying S302 the movement of the one or more bounding boxes 112a-112d. The movement of the one or more bounding boxes 112a-112d may be continuously monitored.

The method comprises a step of evaluating S303 whether the movement of the one or more bounding boxes 112a-112d is in accordance with a predetermined sequence of operations for the equipment enclosed by the bounding box.

The method further comprises a step of performing S304 one or more actions in response to the evaluation. The performing S304 of one or more actions in response to the evaluation comprises automatically controlling the operations of one or more equipments 102, 104, 106a-106c.

Automatically controlling the operations of one or more equipments 102, 104, 106a-106c may comprise: identifying whether the bounding box 112a-112d enclosing one equipment 102, 104, 106a-106c overlaps the bounding box of another equipment when moving according to the predetermined sequence of operations; and allowing the overlap of the bounding boxes in response to identifying that the movement of the bounding boxes 112a-112d is executed in accordance with a planned operation.

Automatically controlling the operations of one or more equipments 102, 104, 106a-106c may comprise identifying whether the movement of the one or more bounding boxes 112a-112d enclosing the one or more equipments 102, 104, 106a-106c is not in accordance with a planned operation and controlling the one or more equipments 102, 104, 106a-106c to avoid the one or more equipments 102, 104 and 106a-106c being in contact, in response to identifying that the movement of the one or more bounding boxes is not in accordance with a planned operation.

The various actions, acts, blocks, steps, or the like in the flow chart may be performed in the order presented, in a different order or simultaneously. Further, in some embodiments, some of the actions, acts, blocks, steps, or the like may be omitted, added, modified, skipped, or the like without departing from the scope of the invention.

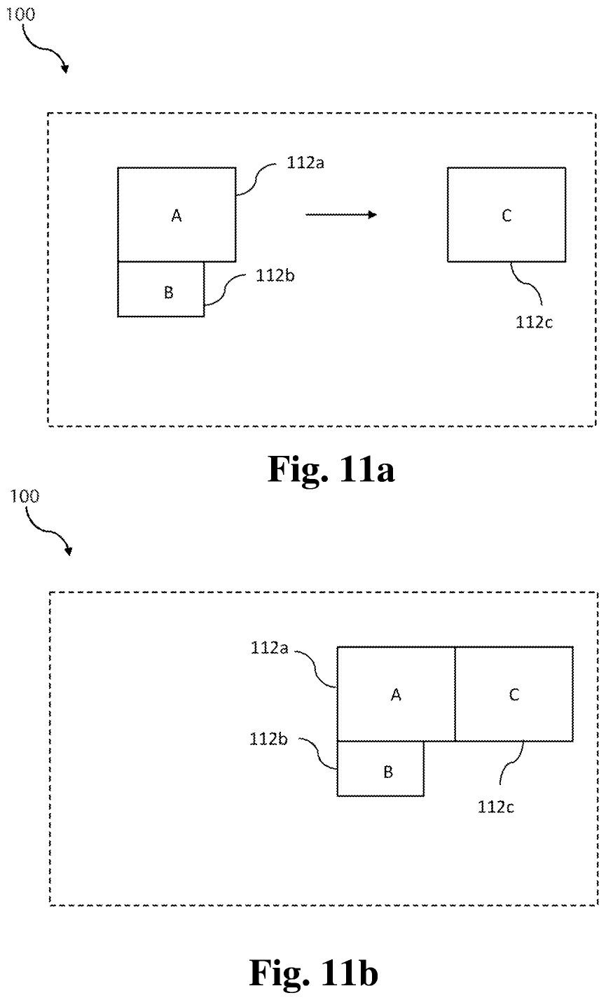

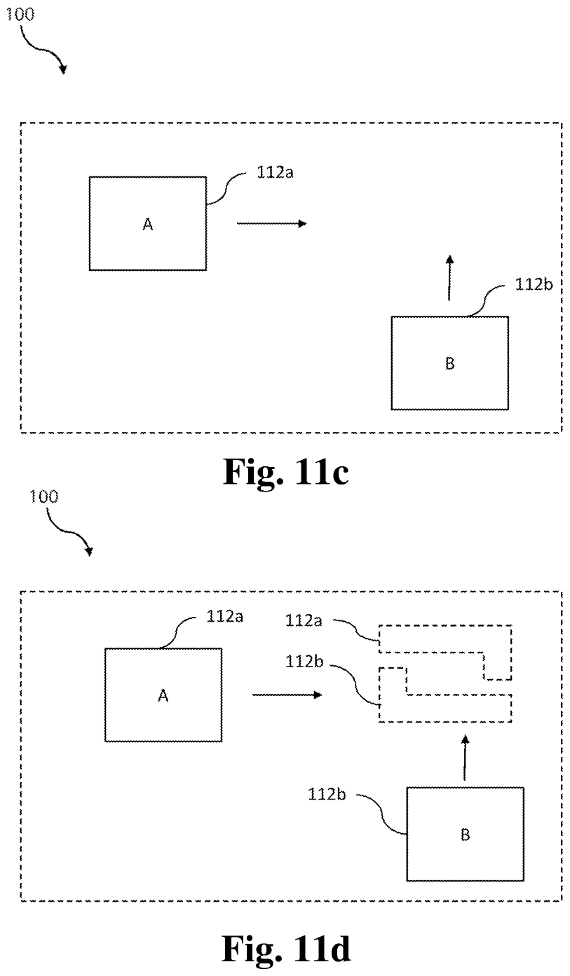

FIGS. 11a and 11b illustrate movement of equipments A, B and C on the drill floor 100 by enclosing the equipments in bounding boxes. As illustrated in FIG. 11a, the equipments A, B and C are illustrated in bounding boxes 112a, 112b and 112c respectively. The equipments A and B are moving towards equipment C. In this embodiment, a control system node 500 may be configured to identify the movement of the bounding boxes 112a and 112b and thereby identifying the movement of equipments A and B. The control system node 500 may be configured to evaluate whether the movement of the one or more bounding boxes 112a and 112b is in accordance with the required sequence of operations on the drill floor 100. If it is determined that the movement of the one or more bounding boxes 112a and 112b is in accordance with the required sequence of operations on the drill floor 100, then the control system node 500 allows the movement of the equipments A and B towards the equipment C. Thus, the equipments A and B in bounding boxes 112a and 112b are moved towards the equipment C in the bounding box 112c as illustrated in FIG. 11b.

In an example, the movement of the one or more bounding boxes 112a-112c are tracked continuously to determine whether the equipments enclosed in those bounding boxes 112a-112c are moving in accordance with the required sequence of operations on the drill floor 100. In case, any of the equipment A, B C or the like is found to be in motion and is not in accordance with the required sequence of operations, then the control system node 500 may be configured to alter or vary the movement of any of the equipment A, B, C or the like to align that equipment in accordance with the required sequence of operations on the drill floor 100. Thus, the control system node 500 may be configured to automatically control the operations of one or more equipments A, B, C or the like by monitoring the movement of the one or more bounding boxes 112a, 112b and 112c respectively.

FIGS. 11c and 11d illustrate a variation in size and shape of the bounding boxes in accordance with the type of operations of the equipments. In an embodiment, the size and the shape of each bounding box 112a-112c is configurable based on state of the one or more equipments on the drill floor 100. Alternatively, the size and the shape of each bounding box 112a-112c is automatically varied in accordance with planned sequence of operation of the one or more equipments. As illustrated in FIG. 11c, the equipment A enclosed in the bounding box 112a is moving in a horizontal direction and the equipment B enclosed in the bounding box 112b is moving in a vertical direction. In this embodiment, when the equipment A and equipment B are moving close to each other to be in contact for a planned operation on the drill floor 100, the size and shape of the bounding boxes 112a and 112b are varied automatically as illustrated in FIG. 11d. Therefore, the size and shape of each bounding box 112a-112c may be automatically varied in accordance with planned sequence of operations on the drill floor 100.

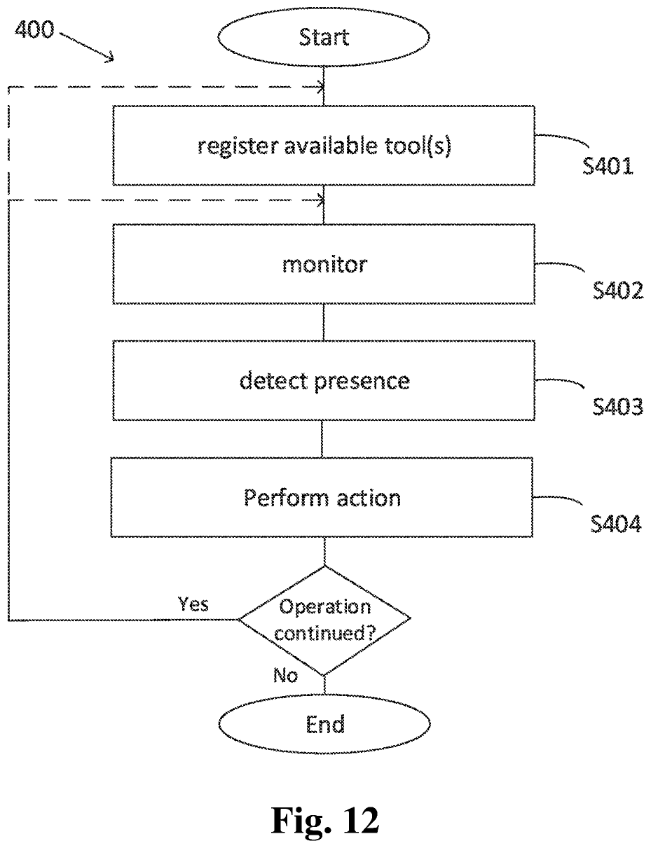

FIG. 12 is a flow chart illustrating a method 400 for monitoring tools in a drilling operation area 100.

The method comprises a step of registering S401 available tools in the drilling operation area 100.

The method further comprises a step of monitoring S402 one or more tools of the registered available tools, said monitored one or more tools being carried 100 for performing various operations on the equipments 102, 104, 106a-106c.

The method further comprises a step of detecting presence S403 of the one or more tools on the equipments 102, 104, 106a-106c upon completion of the various operations on the equipments 102, 104, 106a-106c.

The method further comprises a step of performing S404 one or more actions in response to detecting the presence of the one or more tools on the equipments 102, 104, 106a-106c. The performing of one or more actions may comprise one or more from the following: activating at least one of an alarm, a buzzer, a safety barrier and a light indicator to indicate safety about impending risk to one or more persons in the drilling operation area.

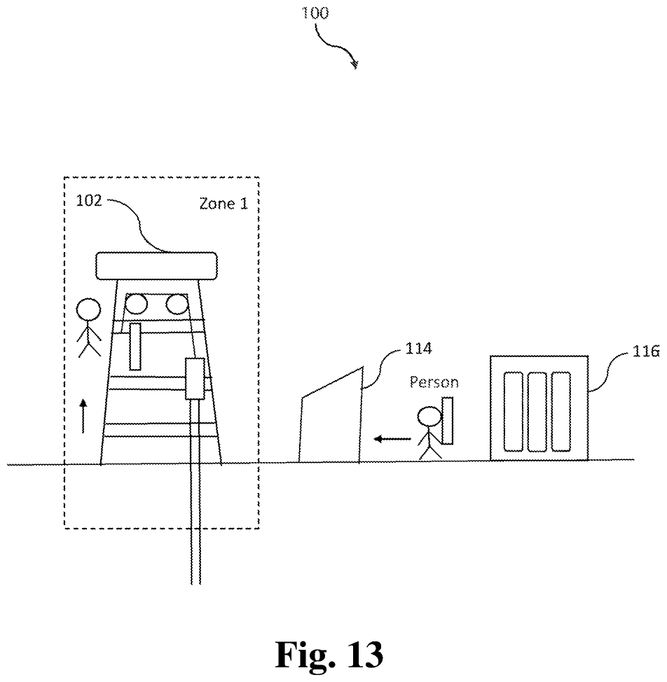

FIG. 13 is an example illustration for providing a safety indication to the person about presence of various tools on the equipments. As depicted in FIG. 13, the drilling operation area such as a drill floor 100 comprises a derrick 102, a scanner 114 and a storage area 116 having various tools and objects for performing operations on the derrick 102. The scanner 114 can be configured to communicate with the control node 500 for example in the drillers cabin 108 through a wired medium or a wireless medium. In this example, the various tools and objects in the storage area 116 are registered by assigning a unique identifier to each tool. For example, the unique identifier can be a RFID or any suitable identifier for uniquely identifying the tools and objects in the storage area 116. The person(s) on the drill floor 100 may carry various tools for performing various operations on the derrick 102. The various tools carried by the person(s) can be scanned by the scanner 116, which may identify the number of tools being carried into the derrick 102. After completion of required operations on the derrick 102, the scanner 106 determines whether the number of tools carried to the derrick 102 are equal to the number of tools brought back to the storage area 116. In case, the scanner 116 determines that the number of tools carried to the derrick 102 are equal to the number of tools brought back to the storage area 116, the scanner 116 indicates the control system node 500 regarding the mismatch in the number of tools. The control system node 500 can be configured to perform various actions such as activating at least one of an alarm, a buzzer, a safety and a light indicator as illustrated in FIGS. 4a and 4b. These actions indicate the person(s) on the drill floor 100 about an impending drop of the tool(s) from the derrick 102. Therefore, the safety indications can be provided when there exists a mismatch between the number of tools carried to the derrick 102 and the number of tools brought back to the storage area 116.

Although, the derrick 102 is illustrated in FIG. 13, it should be noted that the various tools or objects may be carried for performing various operations on various equipments (102, 104, 106a-106c) during oil gas operation on the drill floor 100.

In some examples, the various tools may be scanned for identification of the tools using the scanner 114 and the tools which may be used on the equipments (102, 104 and 106a-106c) may be identified using equipment sensors attached to those euipments. Thus, the dynamic position of the tools in the derrick 102 or in other equipments may be tracked using different cameras or with RFIDs or using equipment sensors. Alternatively, the tools can be automatically scanned on different locations in derrick 102 at several levels and may be presented on display screens in the driller's cabin for monitoring the presence of tools on the equipments 102, 104, 106a-106c.

Therefore, by monitoring the tools on the equipments, safety indications can be provided to the person(s) on the drill floor 100 about impending drop of the tool(s) from the equipments 102, 104 and 106a-106c.

In some examples, the equipments in the drilling operation area such as on the drill floor 100 includes robotic arm(s) used for handling hoisting pipes, cylinders and other structures in the drilling operation area such as on the drill floor 100. These robotic arms may form part of equipments on the drill floor 100 for performing required operations on the drill floor 100. Alternatively, the robotic arms may be deployed on the drill floor 100 when required for performing various operations on the drill floor 100. The robotic arm(s) can be monitored and/or controlled as disclosed herein for providing safety to personnel on the drill floor 100. The robotic arms can be automatically monitored and/or controlled by the control system node 500 as disclosed herein based on identification of the personnel on various operation zones of the drill floor 100. The movement of the robotic arm can be controlled in accordance with the positions of the personnel on the drill floor 100 to provide safety to the personnel on the drill floor 100.

In an example, the movement of the robotic arm can be dynamically tracked and the operation of the robotic arm can be automatically controlled in accordance with the position of the personnel on the drill floor 100 such that to avoid a collision between the robotic arm and the personnel on the drill floor 100.

In an example, the movement of the robotic arm and its operations may be temporarily stopped upon detecting the personnel in proximity to the robotic arm. The operational area of the robotic arm may be limited or the sequence of operations of the robotic arm may be altered when the personnel are detected in a safety zone in proximity of the robotic arm

In an example, one or more operating areas of the robotic arm can be defined and the operations of the robotic arm in those areas can be automatically controlled to avoid the robotic arm colliding with personnel on the drill floor 100.

In another example, speed of the robotic arm can be regulated by the operators for example in the driller's cabin 108. Alternatively, the maximum speed of the robotic arm will be limited to appropriate safety level of the personnel on the drill floor 100. The operators of the drill floor monitor the operations on the drill floor with good line of sight for the operational area of the robotic arm.

The robotic arm(s) on the drill floor 100 may be enabled with a park mode in which the motors are deenergized with brakes engaged.

In some embodiments, the operation zone of the robotic arm may be marked on the drill floor. For example, the safety zone of the robotic arm may be marked as red zone and the safety indications can be provided to the personnel to alert the personnel about possible risks of entering the safety zone of the robotic arm.

The control system node 500 and the method described above provides various effective safety indications to the personnel working together in a drilling operation area with the highest possible safety level for personnel. The proposed method and control system node can be used to remove various impending risks to the personnel in the drilling operation area and thereby improving administrative capacity on the drill floor 100. The proposed method can be used to provide safety indications which may alert the personnel from entering various zones of the drilling operation area while the equipments are in operation.

The proposed method can be used to track various operations of the equipments (i.e., equipment position, required tools, tubulars /riser position etc.,) and defines safe zones or areas for personnel based on the operations of the equipments.

The solutions disclosed herein can be implemented through at least one software program running on at least one hardware device and performing network management functions to control the elements. The elements shown the figures include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

1-30: (canceled)

31: A method for controlling drilling operations, the method comprising:
defining a plurality of operation zones in a drilling operation area, each operation zone comprising at least one equipment arranged to operate in the operation zone; and
repeatedly performing the steps of:
determining a position of at least one person in the drilling operation area,
determining whether the respective determined position is within any of the defined plurality of operation zones and associating each person to the operation zone in which the person is located,
determining whether the respective determined position is within a safety zone in proximity to the one or more equipments,
determining one or more actions to be performed with regard to each operation zone in which the person has been determined to be present, wherein the at least one action is determined dependent on whether the position of the person is in the safety zone or not, and
transmitting one or more control signals for controlling the drilling operations in accordance with the determined one or more actions.

32: The method as recited in claim 31, where the step of determining the one or more actions comprises determining a first type action when the person has been determined to be in the safety zone and determining a second type action when no person has been determined to be in the safety zone.

33: The method as recited in claim 32, wherein the second type action is determined based on a number or persons, which has been determined to be present within the operation zone.

34: The method as recited in claim 31, wherein an extension of the plurality of operation zones are defined in accordance with a type of operations carried out by the at least one equipment in the operation zone.

35: The method as recited in claim 34, wherein the extension of the plurality of operation zones are adaptively redefined in accordance with the type of operations carried out by the at least one equipment in the respective operation zone.

36: The method as recited in claim 31, wherein a size and a shape of each operation zone is configurable.

37: The method as recited in claim 31, wherein the step of determining the position of the person in the drilling operation area comprises extracting data related to the position of the person through one or more sensors installed in the plurality of operation zones; and calculating a location of the person based on the extracted data.

38: The method as recited in claim 31, wherein the step of determining whether the position of the person is in the safety zone comprises:
obtaining a bounding box enclosing the person;
obtaining one or more bounding boxes enclosing the one or more equipments in each operation zone; and
determining whether the person is proximate the at least one equipment based on a relative position between the bounding box of the person and the bounding boxes of the one or more equipments.

39: The method as recited in claim 31, wherein,
at least one of the plurality of operation zones comprises multiple sub-zones, and
one of the multiple sub-zones is the safety zone.

40: The method as recited in claim 31, further comprising:
determining for each equipment the safety zone using equipment sensors,
wherein,
the determined safety zone is used in determining whether the respective determined position is within the safety zone.

41: The method as recited in claim 31, wherein the method further comprises:
determining an operational status of the one or more equipments,
wherein,
the at least one action is determined based on the operational status.

42: The method as recited in claim 31, wherein the method further comprises:
obtaining a sequence of instructions for execution of one or more operations of the one or more equipments of at least one of the plurality of operation zones; and
controlling the one or more equipments in accordance with the obtained sequence of instructions.

43: The method as recited in claim 42, wherein the step of controlling the one or more equipments comprises at least one of:
altering one or more planned operations of the one or more equipments; and
delaying one or more planned operations of the one or more equipments.

44: The method as recited in claim 42, wherein automatically controlling the operations of the one or more equipments comprises:
executing a first instruction in the sequence of instructions;
redefining the plurality of operation zones upon executing the first instruction; and
executing a second instruction in the sequence of instructions.

45: The method as recited in claim 31, further comprising a step of:
identifying whether the person in the operation zone is an authorized person;
wherein,
the one or more actions to be performed is determined based on the identification of whether the person in the operation zone is the authorized person.

46: The method as recited in claim 45, further comprising:
providing a safety indication to the person if the identified person is not the authorized person.

47: A method for monitoring operations in a drilling operation area, the method comprising:
providing one or more bounding boxes enclosing one or more equipments in each operation zone among a plurality of operation zones of a drill floor;
identifying a movement of the one or more bounding boxes;
evaluating whether the movement of the one or more bounding boxes is in accordance with a predetermined sequence of operations for the one or more equipments enclosed by the one or more bounding boxes; and
performing one or more actions in response to the evaluation.

48: The method as recited in claim 47, wherein a size and a shape of each bounding box is configurable.

49: The method as recited in claim 48, wherein the size and the shape of each bounding box is configurable based on a state of the one or more equipments.

50: The method as recited in claim 48, wherein the size and the shape of each bounding box is automatically varied in accordance with a planned sequence of operation of the one or more equipments.

51: The method as recited in claim 47, wherein,
the movement of the one or more bounding boxes is continuously evaluated, and
the performing of one or more actions in response to the evaluation comprises automatically controlling the operations of the one or more equipments.

52: The method as recited in claim 51, wherein automatically controlling the operations of the one or more equipments comprises:
identifying whether the bounding box enclosing one equipment overlaps the bounding box of another equipment when moving according to the predetermined sequence of operations; and
allowing the overlap of the bounding boxes in response to identifying that the movement of the bounding boxes is executed in accordance with a planned operation.

53: The method as recited in claim 51, wherein automatically controlling the operations of one or more equipments comprises:
identifying whether the movement of the one or more bounding boxes enclosing the one or more equipments is not in accordance with the planned operation; and
controlling the one or more equipments to avoid the one or more equipments being in contact, in response to identifying that the movement of the one or more bounding boxes is not in accordance with the planned operation.
